(19) United States
(12) Patent Application Publication
(10) Pub. No.: US 2014/0042722 A1
(43) Pub. Date: Feb. 13, 2014

(54) Axle Assembly

(71) Applicant: Duy Lam, Baltimore, OH (US)

(72) Inventor: Duy Lam, Baltimore, OH (US)

(73) Assignee: ArvinMeritor Technology, LLC, Troy, MI (US)

(21) Appl. No.: 13/568,183

(22) Filed: Aug. 7, 2012

(51) Int. Cl. B62D 7/18

(52) U.S. Cl. 280/93.512

(57) ABSTRACT

An axle assembly having an axle beam, a kingpin, and a steering knuckle. The axle beam has a kingpin hole that receives the kingpin and a fastener hole that extends from the kingpin hole. A fastener is disposed in the fastener hole and engages the kingpin to inhibit movement of the kingpin.

### TECHNICAL FIELD

The present application relates to an axle assembly that may be provided with a vehicle.

### BACKGROUND

A steering knuckle connected to an axle is disclosed in U.S. Pat. No. 6,419,250.

### SUMMARY

In at least one embodiment, an axle assembly is provided. The axle assembly may include an axle beam, a kingpin, a steering knuckle, and a fastener. The axle beam may have a kingpin hole and a fastener hole. The kingpin hole may be disposed along an axis. The fastener hole may extend radially with respect to the axis. The kingpin may be disposed in the kingpin hole. The steering knuckle may be rotatably mounted to the kingpin. The fastener may be disposed in the fastener hole and may engage the kingpin to inhibit movement of the kingpin.

In at least one embodiment, an axle assembly is provided. The axle assembly may include an axle beam, a kingpin, a steering knuckle, and first and second fasteners. The axle beam may include a kingpin hole and first and second fastener holes. The kingpin hole may be disposed along an axis. The first and second fastener holes may be spaced apart from each other and may extend along first and second fastener hole axes, respectively, that may be disposed at an angle with respect to each other. The kingpin may be disposed in the kingpin hole. The steering knuckle may be rotatably mounted to the kingpin. The first and second fasteners may be disposed in the first and second fastener holes, respectively. The first and second fasteners may each have a first end that engages the kingpin to fixedly secure the kingpin to the axle beam.

In at least one embodiment, an axle assembly is provided. The axle assembly may include a kingpin, a steering knuckle, and an axle beam. The steering knuckle may be rotatably disposed on the kingpin. The steering knuckle may have first and second arms that may have first and second holes, respectively. The axle beam may have a kingpin hole and first and second sets of fastener holes. The kingpin hole may be disposed along an axis and may receive the kingpin. The first set of fastener holes may extend radially with respect to the axis and may be disposed closer to the first arm than the second arm. The second set of fastener holes may extend radially with respect to the axis and may be disposed closer to the second arm than the first arm. Each member of the first and second sets of fastener holes may receive a fastener that has a first end that engages the kingpin. The fasteners may cooperate to inhibit movement of the kingpin with respect to the axle beam.

### BRIEF DESCRIPTION OF THE DRAWINGS

FIG. 1 is a perspective view of an axle assembly.

FIG. 2 is a side section view of the axle assembly of FIG. 1.

FIG. 3 is a section view of the axle assembly of FIG. 1 along section line 3-3.

FIG. 4 is a perspective view of another embodiment of an axle assembly.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

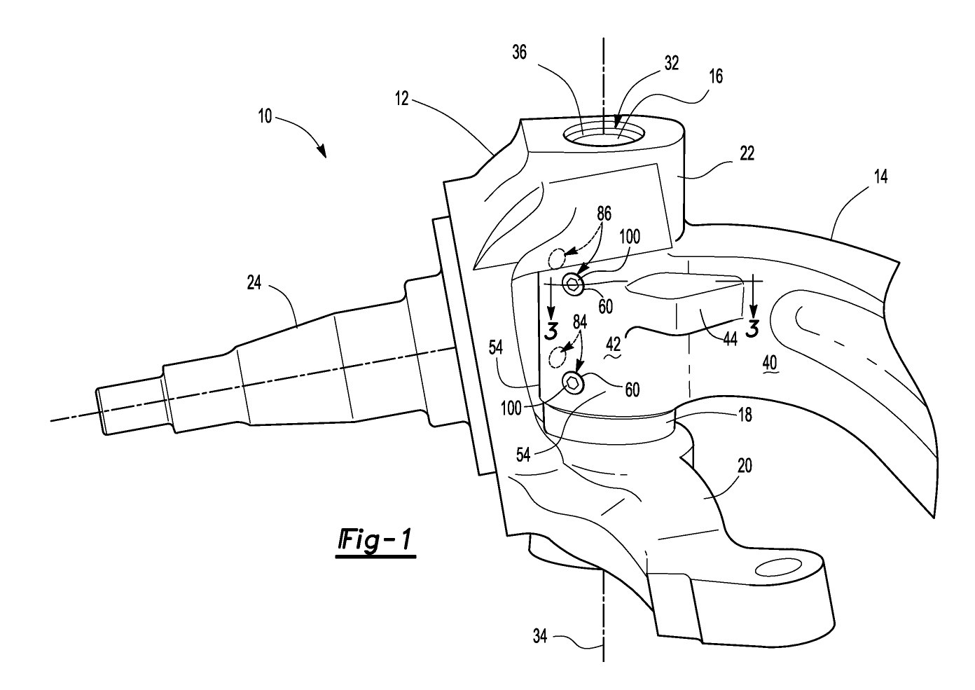

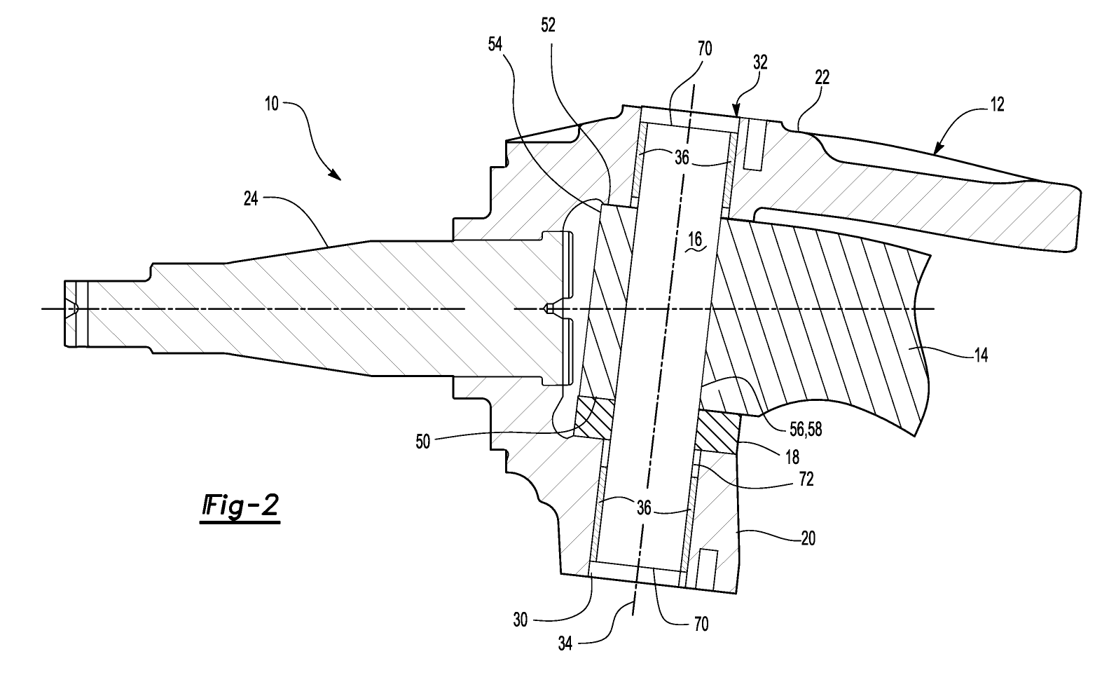

Referring to FIGS. 1 and 2, an exemplary axle assembly 10 is shown. The axle assembly 10 may be provided with a motor vehicle, such as a truck, bus, farm equipment, military transport or weaponry vehicle, or cargo loading equipment for land, air, or marine vessels. The axle assembly 10 may include a steering knuckle 12, an axle beam 14, a kingpin 16, and a thrust bearing 18.

The steering knuckle 12 may interconnect the axle beam 14 to a vehicle wheel and may be part of a steering system that may steer or change the direction of travel of the vehicle. In at least one embodiment, the steering knuckle 12 may include a first arm 20, a second arm 22, and a spindle 24.

The first and second arms 20, 22 may be spaced apart from each other and may include first and second holes 30, 32, respectively. The first and second holes 30, 32 may be coaxially disposed or aligned along an axis 34. In addition, the first and second holes 30, 32 may each receive a bushing or bearing 36 as well as the kingpin 16.

The bearings 36 may facilitate rotation of the steering knuckle 12 about the axis 34 and with respect to the axle beam 14. Each bearing 36 may have an outer surface and an inner surface. The outer surface of the bearing 36 may engage a surface of the steering knuckle 12 that defines a corresponding hole 30, 32. The inner surface of the bearing 36 may be disposed opposite the outer surface and may engage the kingpin 16.

The spindle 24 may support a wheel hub assembly that facilitates mounting and rotation of a vehicle wheel. More specifically, the spindle 24 may support one or more wheel bearings that support and facilitate rotation of a vehicle wheel. The spindle 24 may extend along a second axis that extends away from the axle beam 14. The spindle 24 may be integrally formed or cast with the first and/or second arms 20, 22 such that the spindle 24 is not a separate component. Alternatively, the spindle 24 may be provided as a separate component that is fastened to the steering knuckle 12 in one or more embodiments.

The axle beam 14 may be configured to be mounted to a vehicle and may be part of a vehicle suspension system. The axle beam 14 may be made of any suitable material, such as a metal or metal alloy. In addition, the axle beam 14 may be a forging and may have a unitary one-piece construction. In at least one embodiment, the axle beam 14 may include a beam portion 40, an end portion 42, and one or more stops 44.

The beam portion 40 may be configured to be mounted to the vehicle. In at least one embodiment, the beam portion 40 or a portion thereof may have a generally I-shaped cross section.

The end portion 42 may be disposed at an end of the beam portion 40. As such, the end portion 42 may be integrally formed with the beam portion 40. The end portion 42 may include a first surface 50, a second surface 52, an outer surface 54, an inner surface 56, a kingpin hole 58, and at least one fastener hole 60.

The first surface 50 may face toward the first arm 20. In at least one embodiment, the first surface 50 may extend around the kingpin 16 and may be substantially planar.

The second surface 52 may be disposed opposite the first surface 50 and may face toward the second arm 22. In at least one embodiment, the second surface 52 may extend around the kingpin 16 and may be substantially planar. In addition, the second surface 52 may be disposed substantially parallel to the first surface 50 in one or more embodiments.

The outer surface 54 may extend from the first surface 50 to the second surface 52. The outer surface 54 may be curved and a portion of the outer surface 54 may be radially disposed with respect to the axis 34 in one or more embodiments.

The inner surface 56 may be disposed opposite the outer surface 54 and may at least partially define the kingpin hole 58. The kingpin hole 58 may be configured to receive the kingpin 16. The kingpin hole 58 may extend from the first surface 50 to the second surface 52 and may be centered about and extend along the axis 34. In addition, the kingpin hole 58 may be spaced apart from the outer surface 54.

The kingpin 16 may be disposed in the kingpin hole 58. The kingpin 16 may couple the steering knuckle 12 to the axle beam 14 such that the steering knuckle 12 may pivot about the kingpin 16. More specifically, the kingpin 16 may extend through the kingpin hole 58 in the axle beam 14 such that opposing ends 70 of the kingpin 16 may each be disposed proximate or received in corresponding bearings 36 disposed in the first and second holes 30, 32. The kingpin 16 may have an outside surface 72. In at least one embodiment, the kingpin 16 may extend along the axis 34 and may be generally cylindrical. In such embodiments, the outside surface 72 may be radially disposed with respect to the axis 34 and may be an outside circumferential surface of the kingpin 16.

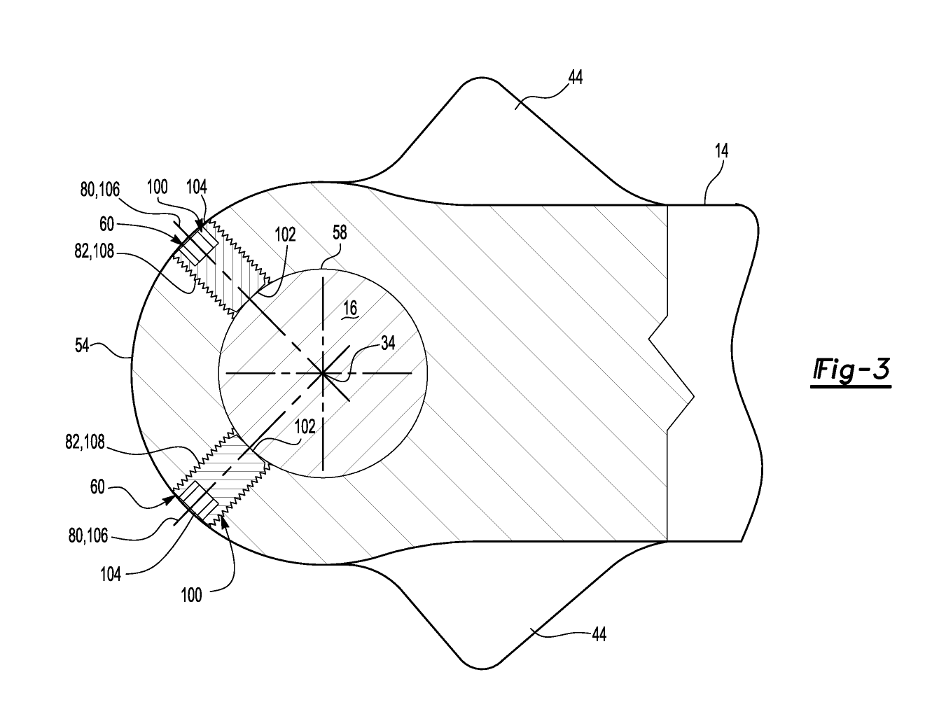

One or more fastener holes 60 may be provided with the end portion 42. A fastener hole 60 may be a through hole that extends from the outer surface 54 to the inner surface 56. In addition, a fastener hole 60 may extend along a fastener hole axis 80. For example, a fastener hole 60 may be oriented such that the fastener hole 60 or fastener hole axis 80 extends radially with respect to the axis 34 as is best shown in FIG. 3. As such, the fastener hole 60 may extend in a single direction from the kingpin hole 58 and away from the axis 34 such that the kingpin hole 58 creates one opening in the outer surface 54 and one opening in the inner surface 56.

The fastener holes 60 may be provided in any suitable quantity. For example, two pairs of fastener holes 60 are provided in the embodiment shown in FIG. 3, although a greater or lesser number of fastener holes 60 may be provided in other embodiments. The fastener holes 60 may be spaced apart from each other and may be oriented in any suitable angular direction to help secure the kingpin 16. For instance, in the embodiment shown, the fastener holes 60 are oriented such that the fastener hole axes 80 are disposed substantially perpendicular to each other and the axis 34.

A fastener hole 60 may be at least partially threaded or may have a threaded portion 82 and may be configured to receive a fastener as will be discussed in more detail below.

Fastener holes 60 may be provided in one or more sets or groups. For example, in FIG. 1 a first set 84 of fastener holes 60 is provided near the first arm 20 and a second set 86 of fastener holes 60 is provided near the second arm 22. The first and second sets 84, 86 of fastener holes 60 may be spaced apart from each other. Moreover, members of a set may have fastener hole axes 80 that are coplanar or disposed in a common plane. For example, the fastener hole axes 80 of the first set 84 of fastener holes 60 may be disposed a common distance from the first arm 20 and the fastener hole axes 70 of the second set 86 of fastener holes 60 may be disposed a common distance from the second arm 22. As such, the first set 84 of fastener holes 60 or its fastener hole axes 80 may be disposed in a first plane and the second set 86 of fastener holes or its fastener hole axes 80 may be disposed in a second plane that is substantially parallel to the first plane. Such planes may also be disposed substantially perpendicular to the axis 34.

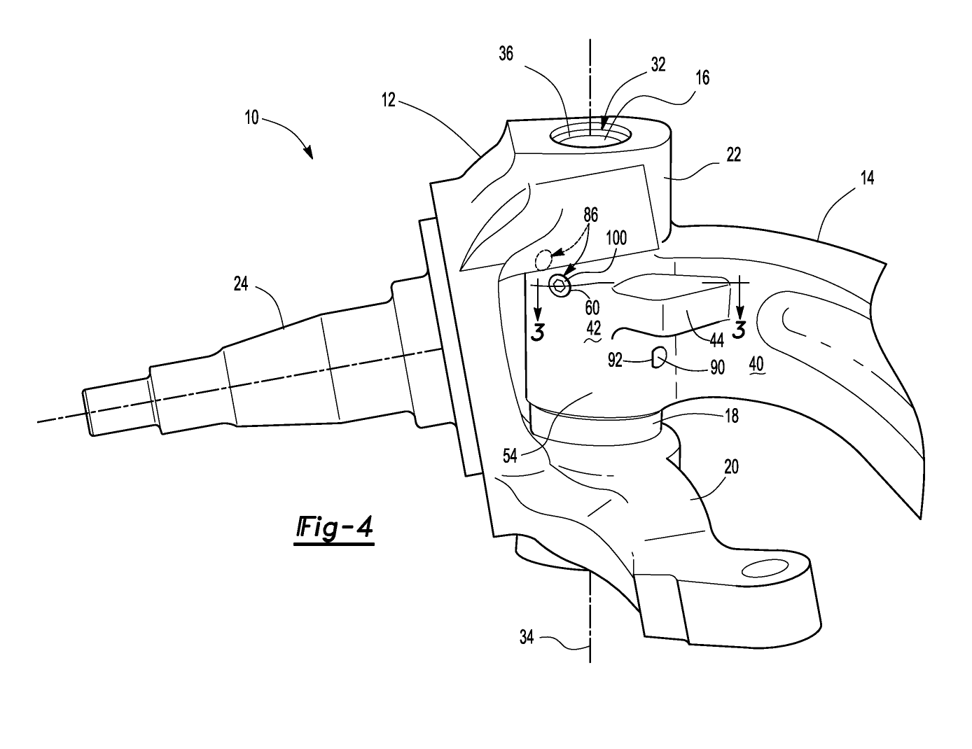

Optionally, a fastener hole 60 or a set of fastener holes 60, such as the first set 84, may be deleted and replaced with a draw key 90 as shown in FIG. 4. The draw key 90 may be disposed in a draw key hole 92 that may be offset from the axis 34 and extend in a chord-like manner through the end portion 42 such that the draw key hole 92 passes from the outer surface 54 to the kingpin hole 58 and from the kingpin hole 58 through the opposite side of the end portion 42 to the outer surface 54. As such, the draw key hole 92 does not extend radially with respect to the axis 34. In addition, the draw key hole 92 may be disposed closer to the first arm 20 than the second arm 22 while the fastener hole 60 may be disposed closer to the second arm 22 to provide a more compact design on the side of the axle beam 14 disposed closed to the spindle 24 to accommodate rotation of the steering knuckle 12.

One or more fasteners 100 may be provided to secure the kingpin 16 to the axle beam 14. More specifically, a fastener 100 may be disposed in a fastener hole 60 and may exert force that inhibits axial and radial movement of the kingpin 16 along the axis 34. A fastener 100, which may be a set screw, may have a first end 102, a second end 104, and a fastener axis 106.

The first end 102 may be configured to engage the kingpin 16. In addition, the first end 102 may be disposed opposite the second end 104.

The second end 104 may be disposed proximate the outer surface 54 of the end portion 42. In at least one embodiment, the second end 104 may be disposed inside the fastener hole 60 when the first end 102 engages the kingpin 16 to help provide clearance from the steering knuckle 12. In addition, the second end 104 may be provided with a recess that is configured to receive a tool to facilitate rotation of the fastener 100.

The fastener axis 106 may extend from the first end 102 to the second end 104. As such, the fastener 100 may extend along the fastener axis 106. In addition, the fastener 100 may have a threaded region 108 disposed between the first and second ends 102, 104. The threaded region 108 may mate with the threaded portion 82 of the fastener hole 60. As such, the fastener 100 may be rotated about the fastener axis 106 to advance the fastener 100 through the fastener hole 60 so that the first end 102 may engage the kingpin 16 to inhibit movement of the kingpin 16.

Referring again to FIGS. 1 and 3, one or more stops 44 may be provided with the axle beam 14. A stop 44 may be configured to engage the steering knuckle 12 to limit rotational movement of the steering knuckle 12 about the axis 34. The stops 44 may extend from and may be integrally formed with the beam portion 40 and/or the end portion 42. In the embodiment shown, two stops 44 are provided that extend from opposite sides of the axle beam 14. In at least one embodiment, each stop 44 may be disposed opposite different fastener holes 60 or different fastener hole axes 80.

The thrust bearing 18 may be provided between the axle beam 14 and the first arm 20 of the steering knuckle 12. The thrust bearing 18 may extend around the kingpin 16 and may facilitate pivotal movement of the steering knuckle 12.

In one or more embodiments, the axle assembly may permit a kingpin to be assembled to an axle beam with fewer draw keys or no draw keys. Deletion of a draw key eliminates associated draw key manufacturing costs as well as the cost of lock nuts that may engage an end of the draw key to secure the draw key to the axle beam. In addition, the deletion of a draw key and lock nuts allows for more compact axle assembly designs in that additional clearance does not need to be provided between the steering knuckle and the draw key and/or lock nut which could otherwise reduce the maximum turning angle or angular rotation of the steering knuckle about the kingpin. Moreover, the location and distance that the draw key extends from the axle beam may be highly variable due to the difficulties associated with providing a draw key hole. More specifically, a draw key hole can wander after a portion of the drill bit first enters the kingpin hole and then reengages the steering knuckle to continue to drill through to the other side. The deletion of a draw key reduces such variability as well as the cost, equipment, and labor associated with drilling a draw key hole in the axle beam. Moreover, draw key elimination simplifies kingpin manufacturing in that flats or flat surfaces do not need to be machined on the outside diameter of the kingpin.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1-6. (canceled)

7. The axle assembly of claim 8 wherein the fastener is a set screw.

8. An axle assembly comprising:
an axle beam that includes:
a beam portion configured to be mounted to a vehicle;
first and second stops that are disposed adjacent to the beam portion and disposed on opposite sides of the beam portion;
an end portion disposed at an end of the beam portion;
a kingpin hole that is provided in the end portion and disposed along an axis, and
first and second fastener holes that each have a threaded portion and are spaced apart from each other and that extend along first and second fastener hole axes, respectively, wherein the first and second fastener holes are disposed at an angle with respect to each other and are disposed at an angle with respect to the beam portion of the axle beam and are disposed above the first and second stops and are not disposed directly opposite the beam portion;
a kingpin disposed in the kingpin hole;
a steering knuckle that is rotatably mounted to the kingpin; and
first and second threaded fasteners disposed in the first and second fastener holes, respectively, wherein the first and second fasteners each have a first end that engages the kingpin to fixedly secure the kingpin to the axle beam;
wherein the first and second stops are configured to engage the steering knuckle to inhibit rotation of the steering knuckle and only one hole from an outer surface of the axle beam to an inner surface of the axle beam that defines the kingpin hole is disposed on each of the first and second fastener hole axes.

9. The axle assembly of claim 8 wherein the first and second fastener hole axes extend radially with respect to the axis.

10. The axle assembly of claim 9 wherein the first and second fastener hole axes are disposed substantially perpendicular to each other.

11. The axle assembly of claim 10 wherein the first and second fastener hole axes are coplanar.

12-13. (canceled)

14. The axle assembly of claim 8 wherein the kingpin has an outside surface that is radially disposed with respect to the axis and wherein the first and second fasteners engage the outside surface.

15. The axle assembly of claim 8 wherein the steering knuckle includes a first arm that has a first hole that receives a first end of the kingpin, a second arm that has a second hole that receives a second end of the kingpin, and a thrust bearing that extends around the kingpin and is disposed between the axle beam and the first arm, wherein the first and second fastener holes are disposed closer to the second arm than the first arm.

16. The axle assembly of claim 15 wherein the axle beam includes a draw key hole that extends through the axle beam such that the draw key hole is not radially disposed with respect to the axis, wherein the draw key hole is disposed closer to the first arm than the first and second fastener holes and wherein the draw key hole receives a draw key.

17. An axle assembly comprising:
a kingpin having an outside circumferential surface that extends from a first end to a second end of the kingpin;
a steering knuckle that is rotatably disposed on the kingpin, the steering knuckle having first and second arms that have first and second holes, respectively; and
an axle beam that includes:
a kingpin hole that is disposed along an axis and that receives the kingpin, and
a first set of fastener holes that extend radially with respect to the axis, wherein the first set of fastener holes is disposed closer to the first arm than the second arm;
a second set of fastener holes that extend radially with respect to the axis, wherein the second set of fastener holes is disposed closer to the second arm than the first arm; and
first and second stops that are disposed opposite each other and that are configured to engage the steering knuckle to inhibit rotation of the steering knuckle;
wherein each member of the first and second sets of fastener holes has a threaded portion that receives a threaded fastener that has a first end that engages the circumferential surface of the kingpin and does not extend into a hole in the kingpin, wherein the fasteners cooperate to inhibit movement of the kingpin with respect to the axle beam; and
wherein the first set of fastener holes are entirely disposed above the first and second stops and disposed closer to the first and second stops than to the first arm and the second set of fastener holes are entirely disposed below the first and second stops and disposed closer to the second arm than to the first and second stops.

18. The axle beam of claim 17 wherein the first set of fastener holes are disposed in a first plane and the second set of fastener holes are disposed in a second plane.

19. The axle beam of claim 18 wherein the first and second planes are disposed substantially parallel to each other.

20. The axle beam of claim 19 wherein the first and second planes are disposed substantially perpendicular to the axis.
